(19) United States
(12) Patent Application Publication
(10) Pub. No.: US 2003/0069917 A1
(43) Pub. Date: Apr. 10, 2003

(54) Balanced client/server mechanism in a time-partitioned real-time operting system

(76) Inventor: Larry J. Miller, Black Canyon City, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/971,940

(22) Filed: Oct. 4, 2001

(51) Int. Cl. G06F 9/00

(52) U.S. Cl. 709/105

(57) ABSTRACT

A method is provided for transferring CPU budget and CPU control between a client thread and a server thread in a client/server pair. A CPU budget is assigned to the client thread, and the client thread begins executing at a scheduled time within a first period. CPU control and any unused CPU budget is transferred, within the first period, to the server thread when the client thread stops executing at which point the server thread begins executing, still within the first period. CPU control and any unused CPU budget are transferred, within the first period, to the client thread when the server thread stops executing.

### TECHNICAL FIELD

The present invention relates to a balanced client/server mechanism, and more particularly to an efficient, yet safe, single processor client/server implementation for use in a time-partitioned real-time operating system utilizing controlled budget transfers between client and server entities.

### BACKGROUND OF THE INVENTION

Generally speaking, operating systems permit the organization of code such that conceptually, multiple tasks are executed simultaneously while, in reality, the operating system is switching between threads on a timed basis. A thread is considered to be a unit of work in a computer system, and a CPU switches or time multiplexes between active threads. A thread is sometimes referred to as a process; however, for purposes of this description, a thread is considered to be an active entity within a process; the process including a collection of memory, resources, and one or more threads.

A real-time operating system may provide for both space partitioning and time partitioning. In the case of space partitioning, each process is assigned specific memory and input/output regions. A process can access only memory assigned to it unless explicit access rights to other regions are granted; i.e. only if another process decides that it will share a portion of its assigned memory. In the case of time partitioning, there is a strict time and rate associated with each thread (e.g., a thread may be budgeted for 5000 ms every 25,000 ms or forty times per second) in accordance with a fixed CPU schedule. A single, periodic thread could, for example, be assigned a real-time budget of 500 ms to accommodate worst-case conditions; i.e. involving all paths and all code. In many cases, however, the thread may need only a portion (e.g. 50 ms) of its 500 ms budget. The unused 450 ms is referred to as slack, and absent anything further, this unused time is wasted. To avoid this, some operating systems utilize slack pools which collect unused time that may then be utilized by other threads in accordance with some predetermined scheme; e.g. the first thread that needs the additional budget takes all or some portion of it. Alternatively, access to the slack pool is based on some priority scheme; e.g. threads that run at the same rate are given slack pool access priority. Still another approach could involve the use of a fairness algorithm. Unfortunately, none of these approaches result in the efficient and predictable use of slack.

Thus, it should be clear that time-partitioned real-time operating systems require that a specific CPU time budget be given to each thread in the system. This budget represents the maximum amount of time the thread can control the CPU's resources in a given period. A thread can run in a continuous loop until its CPU budget is exhausted, at which point an interrupt is generated by an external timer. The operating system then suspends the execution of the thread until the start of its next period, allowing other threads to execute on time. A thread execution status structure is provided to keep track of initial and remaining CPU budget. Since threads must be budgeted for worst-case conditions, only a portion of the budgeted CPU time is utilized in many cases thus reducing CPU efficiency, and slack mechanisms represent only a partial solution.

Two threads can be partners in performing a task (e.g. a client/server relationship for controlling a cursor or display). Generally speaking, a client is a thread executing on a CPU that requests data from another thread or requests that the other thread perform some task on the client's behalf. A server is a thread executing on a CPU that exists for the purpose of servicing client requests to perform tasks or supply data. A client places request for service in a queue during its allotted CPU time budget. The server then retrieves these requests on a first-in first-out basis and processes them during the server's respective CPU time budget. Unfortunately, the client may fill the queue, forcing it to stop operating and thus failing to utilize its entire budget. Likewise, the server may empty the queue prior to the expiration of its allotted CPU budget. For example, if the client/server task involves generating a weather map on a display, there would be significant client/server activity in stormy weather resulting in little, if any, unused CPU budget. If, on the other hand, the weather is clear, there would be relatively little to draw on the display. However, both the client and the server must be budgeted for worst case conditions (i.e. stormy weather) even though in most cases the weather is relatively clear, thus resulting in each utilizing only a portion of its respective CPU budget. The situation is analogous to two workers with strict job assignments adjacent to one another on an assembly line. Keeping both workers busy all the time is difficult. If the first worker performs his work more quickly than the second does, his output queue will eventually back up, and he will have to slow down. If the second worker is faster than the first, he will be repeatedly waiting for work in his input queue. Either way, productivity is lost. The problem is compounded if a mix of products is produced on the same line.

Thus, it can be seen that a time-partitioned real-time operating system is a hostile environment for a client/server architecture with respect to efficiency and budget tuning. As already stated, every thread in a time-partitioned real-time operating system must be given a specific CPU budget within its period or frame. If the amount needed by each entity is consistent over time, choosing these budgets is simple, and the CPU is operated in an efficient manner. If, on the other hand, the client/server workload is variable, and the ratio or balance of work between the client and the server varies, larger amounts of CPU budget can be lost. Further, budget tuning is difficult and critical to achieving acceptable performance. Client and server budgets must each be carefully monitored and coordinated as new functionality is added to the system. Over-budgeting of either the client or the server results in wasted CPU time while under-budgeting either entity by even a very small amount might result in a significant reduction in processing rate.

In view of the foregoing, it should be appreciated that it would be desirable to provide an efficient client/server mechanism for use in a time-partitioned real-time operating system that avoids the necessity of separate and unique client and server budgets and that provides for the free-flow of CPU time between client and server. Additional desirable features will become apparent to one skilled in the art from the foregoing background of the invention and the following detailed description of a preferred exemplary embodiment and appended claims.

### BRIEF SUMMARY OF THE INVENTION

In accordance with the teachings of the present invention, there is provided a method for transferring CPU budget and CPU control between a client thread and a server thread in a client/server pair. A CPU budget is assigned to the client thread, and the client thread begins executing at a scheduled time within a first period. CPU control and any unused CPU budget is transferred, within the first period, to the server thread when the client thread stops executing at which point the server thread begins executing still within the first period. CPU control and any unused CPU budget is transferred, still within the first period, to the client thread when the server thread stops executing.

### BRIEF DESCRIPTION OF THE DRAWINGS

The present invention will hereinafter be described in conjunction with the appending drawing figures, wherein like reference numerals denote like elements, and;

FIG. 1 is a timing diagram illustrating the CPU budget associated with a Thread A;

FIG. 2 is a timing diagram illustrating that Thread A utilizes only a portion of its available CPU budget leaving an unused or wasted portion;

FIG. 3 is a graphical representation of a CPU budget transfer from donor Thread A to beneficiary Thread B;

FIG. 4 is a timing diagram illustrating the transfer of Thread A's unused budget to Thread B's budget;

FIG. 5 is a graphical representation of a bilateral transfer of excess CPU budget between Thread A and Thread B;

FIG. 6 illustrates a bi-directional queue-oriented communication mechanism between a client and a server;

FIG. 7 is a state transition diagram useful in explaining the operation of the bi-directional queue-oriented client/server communication system shown in FIG. 6;

FIG. 8 is a timing diagram illustrating the potential budgeting inefficiencies associated with a client/server system in a time-partitioned real-time operating system;

FIG. 9-FIG. 18 are timing diagrams useful in explaining the process of transferring CPU control and budget between client/server pairs; and

FIG. 19 is a state transition diagram illustrating the process of transferring CPU control and budget between client/server pairs.

### DETAILED DESCRIPTION OF PREFERRED EXEMPLARY EMBODIMENT

The following detailed description of a preferred embodiment is mainly exemplary in nature and is not intended to limit the invention or the application or use of the invention.

The present invention recognized that dramatic increases in CPU efficiency can be achieved while maintaining the benefits of rigid time partitioning if CPU budget is transferred between threads executing in a time-partitioned real-time environment.

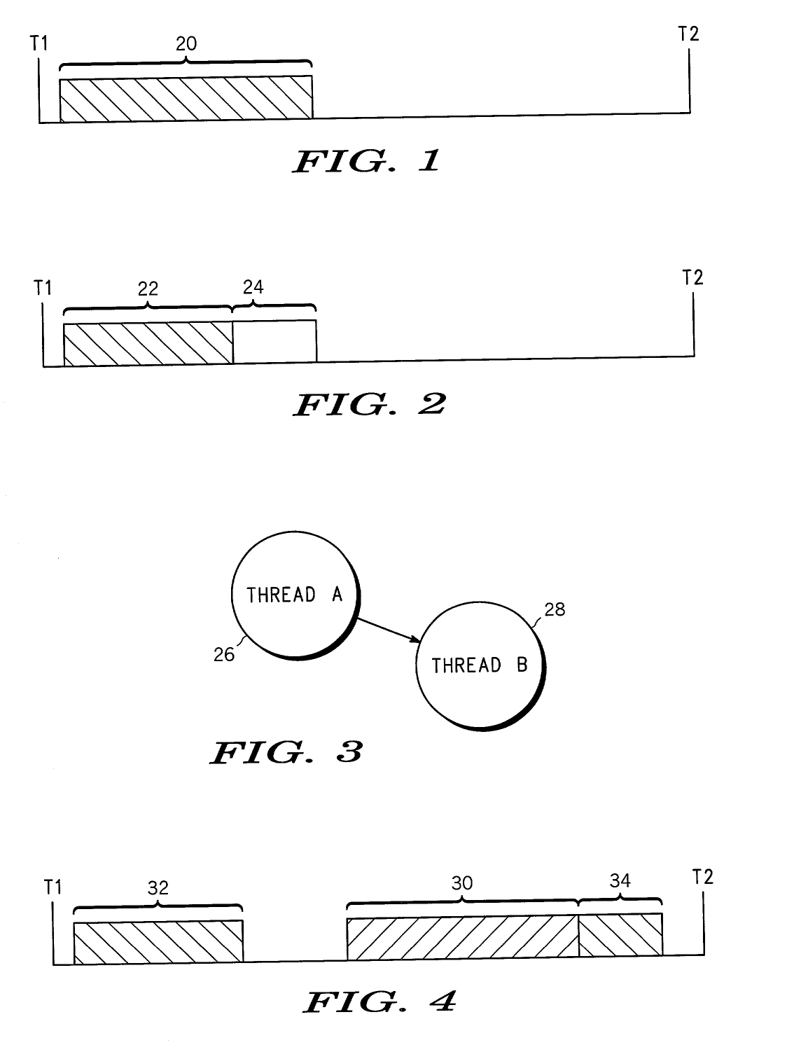

FIG. 1 and FIG. 2 illustrate the potential budgeting inefficiencies associated with a time-partitioned real-time operating system. Referring to FIG. 1, a thread (e.g. Thread A) is shown as having a CPU budget 20 within a frame or period occurring between time T1 and time T2. If Thread A utilizes its entire budget 20, no CPU time is wasted. If however, Thread A utilizes only a portion (e.g. two-thirds) of its budget as is shown in FIG. 2 at 22, one-third of Thread A's budget 24 is wasted and lost.

The inventive budget transfer mechanism recognizes that a time-partitioned real-time operating system could be implemented to permit budget transfers between any two threads. That is, any thread may designate another specific thread as the beneficiary of its unused CPU budget within the same period or frame. Such a budget transfer mechanism is illustrated in FIG. 3 and FIG. 4. Referring to FIG. 3 and FIG. 4, thread A 26 has designated Thread B 28 as its CPU budget beneficiary. Thread B has its own CPU budget 30 within period or frame T1-T2. As was the case in FIG. 2, Thread A has completed its task in only a fraction (e.g. two-thirds) of its allotted CPU budget shown at 32. However, since Thread A has designated Thread B as its beneficiary, the unused one-third of Thread A's budget 34 is transferred to Thread B 28 and added to Thread B's CPU budget 30. Thread B 28 may reside in the same process as Thread A 26, or it might reside in another process.

The transfer of budget occurs automatically upon a synchronization object; for example, a semaphore or an event. An event is a synchronization object used to wake up Thread B 28. For example, Thread A 26 and Thread B 28 may be assigned successive tasks in a sequential process. Thus, upon completing its task, Thread A would voluntarily block (stop executing) and awaken Thread B; i.e. voluntarily give up the CPU and allow the operating system to schedule its beneficiary thread before its own next execution. If at that point, Thread A 26 had excess CPU budget, it is transferred to Thread B 28. A semaphore is likewise a synchronization object; however, instead of awakening its beneficiary thread, it waits to be awakened as would be the case, for example, if Thread A 26 were waiting for a resource to become available. A semaphore may also be used to share a certain number of resources among a larger number of threads.

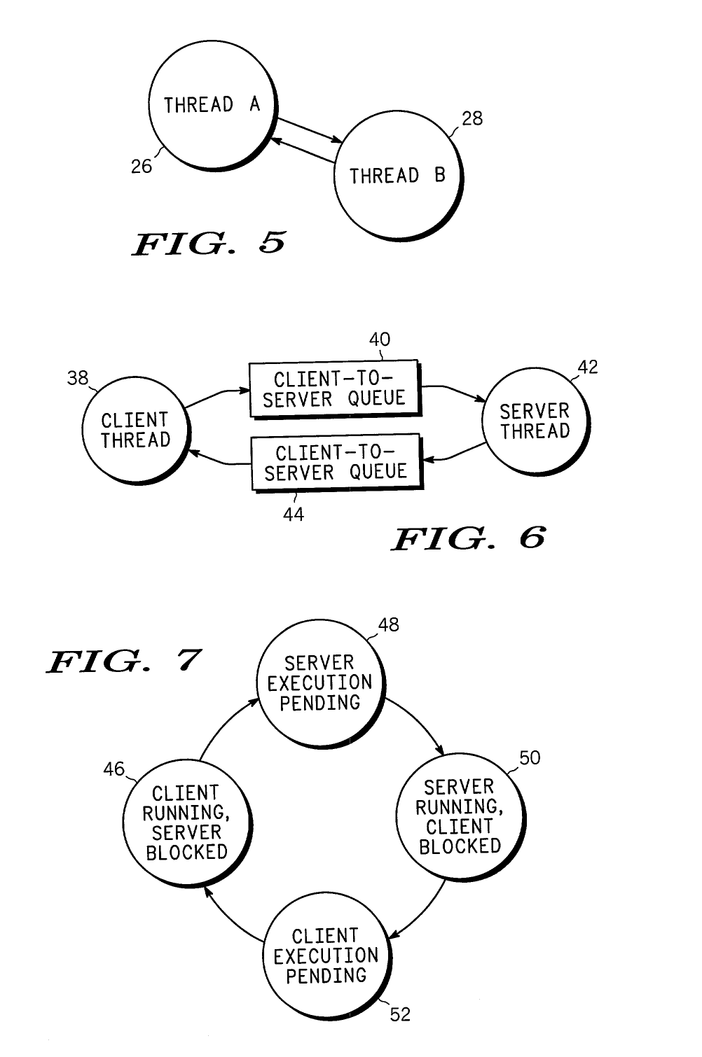

While the CPU budget transfer shown and described in connection with FIG. 3 and FIG. 4 is a unilateral transfer (i.e. budget is transferred only from Thread A 26 to Thread B 28 when Thread A blocks on a synchronization object), it should be clear that there could be a bilateral transfer of CPU budget between Thread A 26 and Thread B 28. For example, referring to FIG. 5, Thread A 26 transfers its remaining budget to Thread B 28 when it blocks on a first synchronization object (i.e. an event or a semaphore) thus transferring control to Thread B 28. Thread B 28 designates Thread A 26 as its budget beneficiary such that when Thread B 28 blocks on a subsequent synchronization event, Thread B 28 transfers its remaining CPU budget back to Thread A 26. It is only necessary that Thread A 26 and Thread B 28 be budgeted for CPU time in the same period or frame.

The bi-directional relationship between Thread A 26 and Thread B 28 shown in FIG. 5 can be expanded to create a balanced client-server mechanism such that when applied to a real-time operating system, it permits the client and server threads to execute alternately in a controlled manner. To accomplish this, the client-server thread must establish a bi-directional queue-oriented means of communication such as is shown in FIG. 6. As can be seen, client thread 38 provides requests for data and service to client-to-server queue 40. Both client thread 38 and server thread 42 create or gain access to a synchronization object such as a semaphore or event in order to allow its partner thread to assume control. Thus, when client thread 38 has completed transferring service requests to client-to-server queue 40 or when client-to-server queue 40 is full or when client thread 38 transmits a data request to client-to-server queue 40 along with an indication that this request must be processed immediately, the client thread produced a synchronization object and blocks on the same synchronization object turning control over to server thread 42. Server thread 42 then retrieves and processes the requests in client-to-server queue 40 and provides the results of such requests to server-to-client queue 44. If server-to-client queue 44 becomes filled with data from server thread 42 or if client-to-server queue 40 is empty or server thread 42 is providing a response to a high priority request for data, server thread 42 similarly blocks on a synchronization object thereby transferring CPU control back to client thread 38. Thus, when either client thread 38 or server thread 42 is prevented from doing productive work, each voluntarily blocks, waking up its partner thread and transferring control thereto.

The operative relationship between client thread 38, client-to-server queue 40, server thread 42, and server-to-client queue 44 is represented by the state transition diagram shown in FIG. 7. Referring to FIG. 6 and FIG. 7, when client 38 is executing, server 42 is blocked, as is shown at 46. When client-to-server request queue 40 becomes full, or when client thread 38 requires immediate response to a service request or when client 38 has no further work to perform, client 38 produces a synchronization object and blocks thereon. At this time, server execution is pending, as is shown at 48. Server thread 42 then assumes control of the CPU, and client 38 is blocked as is shown at 50. That is, server thread 42 becomes the highest priority thread in the system. If server thread 42 is responding to a request for immediate response or if it has filled server-to-client queue 44 or if server 42 has no work to perform (e.g. client-to-server queue 40 is empty or server 42 has completed all tasks), server 42 triggers a synchronization object and blocks thereon. At this stage, client execution is pending as is shown at 52, and then client again becomes the highest priority thread in the system; i.e. client thread 38 is executing and server thread 42 is blocked. Thus, client and server threads 38 and 42 respectively perform controlled transfers to their partner thread under the specific conditions described above. Each thread utilizes a synchronization object to wake up its partner thread. It then blocks on the same object (i.e. voluntarily gives up control of the CPU) and allows the operating system to schedule it's partner thread before it's own next execution.

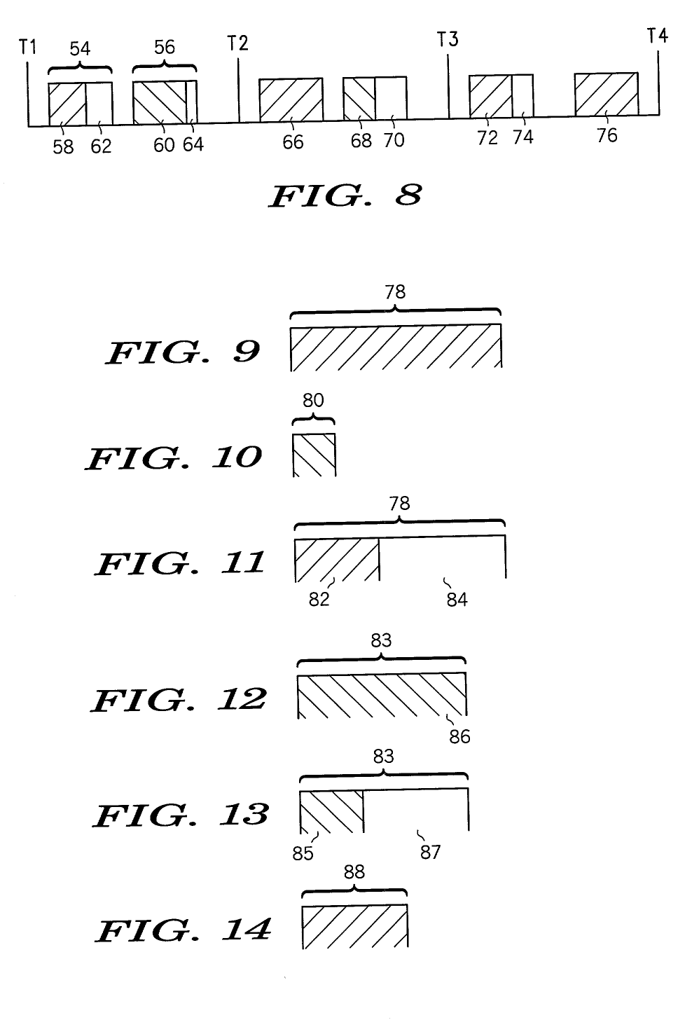

The above described client-server mechanism provides for controlled transfers of the CPU within a period or frame but does not address the problem of unused or wasted budget referred to above. FIG. 8 highlights the potential budgeting inefficiencies associated with hosting a client/server system on a time-partitioned real-time operating system. Referring to time period or frame T₁-T₂ in FIG. 8, a client thread has a budget indicated at 54, and a server thread has a budget as is indicated at 56. Period T₁-T₂ addresses a typical scenario where both the client and the server utilize only portions of their respective CPU budgets 58 and 60. Neither thread required its entire CPU budget to complete its tasks. Thus, the client left unused a portion of its budget 62, and the server left unused a portion of its budget 64. In frame T₂-T₃, the client required its entire budget as is shown at 66, but the server only utilized a portion of its CPU budget 68 giving up the remainder 70. Finally, in time period or frame T₃-T₄, the client used only a portion of its budget 72 leaving a portion 74 unused while the server utilized its entire budget 76.

It should be clear from the description of the budget transfer mechanism given above in connection with FIGS. 3, 4, and 5 and the description of a client/server mechanism wherein there can be multiple transfers of control of CPU control between client and server per period or frame as described in connection with FIGS. 6 and 7, that there could be multiple transfers of CPU control and budget between client server pairs in a given period or frame. The process of transferring CPU control and budget between client server pairs will now be described in connection with FIGS. 9-18 wherein FIG. 9 represents the CPU time budget for a client and FIG. 10 represents the CPU time budget for a server which is partnered with the client. Assume initially that the client is running and the server is blocked and that the client utilizes only a portion 82 of its total budget 78 leaving an unused portion 84. When the client utilizes a synchronization object to transfer control of the CPU to its partner server, it also transfers the client's excess budget 84. Thus, the server effectively has a new budget 83, which consists of its original budgets 80 plus unused portion 84 transferred from the client thread as shown in FIG. 12. Assume now that the server is running and the client is blocked, and the server utilizes only a portion 85 of its budget 83 leaving an unused portion 87 as shown in FIG. 13. When the server gives up CPU control to its client partner upon a synchronization object, unused budget portion 87 is transferred to the client giving it a new budget 88 as is shown in FIG. 14. Thus, the client now has an effective budget equal to its original budget 78 plus unused portion 87. At this point, the client is again executing and uses only a portion of its budget 88 leaving a portion 89 unused as is shown in FIG. 15. As you might expect, when the client blocks and transfers CPU control to the server, portion 89 is transferred to the server giving it a new budget 90 as is shown in FIG. 16. Again, the server uses only a fraction 93 of its original budget leaving a portion 92 unused. Finally, for the sake of avoiding unnecessary repetition, when CPU control is again transferred to the client as a result of the server blocking on a synchronization object, unused budget time 92 is transferred to the client, as is shown in FIG. 18. Thus, it should be clear that both control and unused budget can be transferred between client/server pairs a plurality of times within a given period or frame.

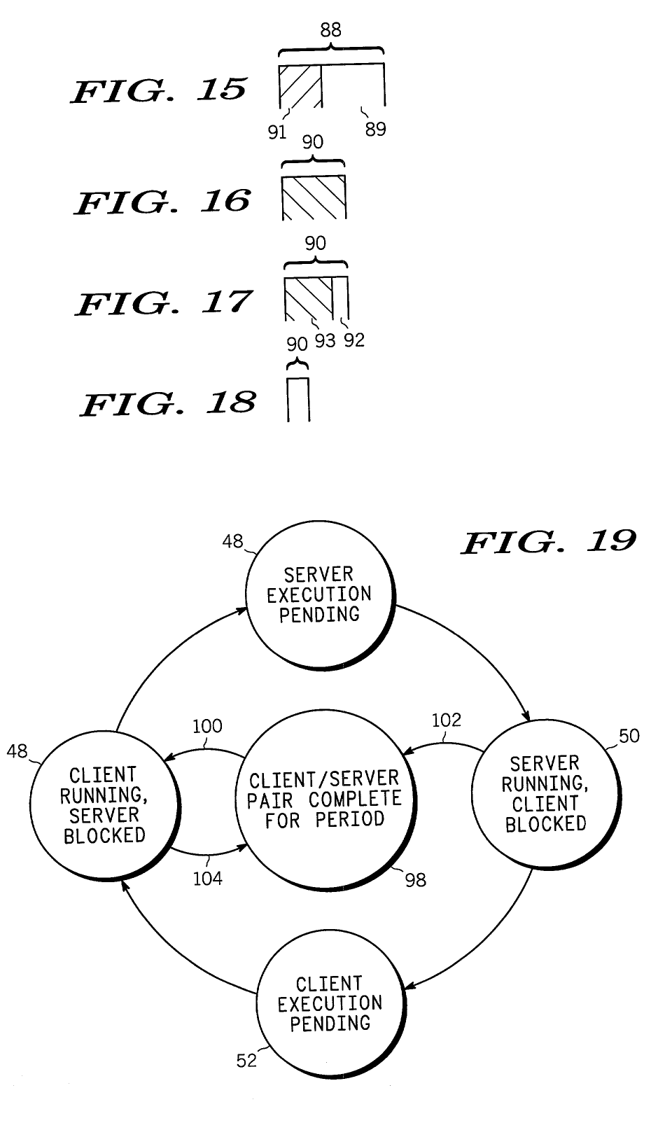

The inventive process for transferring CPU control and budget between client and server as described in connection with FIGS. 9-18 is also illustrated in the state transition diagram shown at FIG. 19. This diagram is similar to that shown in FIG. 7, and like states are denoted with like reference numerals and operate in the same manner as previously described in connection with FIG. 7. The budget transfer aspect of the state transition diagram is reflected by state 98 and transitions 100, 102 and 104. The process is initialized when the client/server pair has completed their executions for a given period, as is shown at 98. When a new period begins, the client thread is scheduled to run before the server as is indicated by transition 100. Next, the client executes, and the server is blocked as is shown at 46 until one of the above described control transfers occur at which time the client blocks, transfers its remaining CPU budget to the server, and server execution is pending as is shown at 48. At this point, the server thread becomes the highest priority thread in the system and begins executing as is shown at 50. If the server thread should consume its budget or the prescribed task for that period is completed, execution of the client and server threads is complete for that period as is indicated by arrow 102 and state 98. If the task is not completed and CPU budget remains, the server again blocks on a synchronization object and transfers its remaining CPU budget to the client. At this point, the server thread is blocked, and client execution is pending as is shown at 52. When the client thread becomes the highest priority thread in the system, it begins executing, and the server remains blocked as is shown at 46. This process continues until one of the two threads exhausts its CPU budget, in which case the client server pair ceases executing as is represented by transitions 102 or 104 and state 98.

The above described balanced client/server mechanism provides several distinct advantages. First, there is a free-flow of CPU budget time between the client and the server. CPU time balance between the client and server is no longer an issue, and worst-case CPU requirements can be assessed for the client server thread pair rather than individually. Efficiency is increased to nearly 100%, as only context switch time is lost. This factor greatly improves performance because of the reduction in combined CPU budget needed for each client/server pair. Safety is preserved because budget transfers are voluntary; i.e. budget can only be received as a gift and never taken by force. Requests for server-maintained data can be serviced quickly. Since multiple transfers of control can occur in one period or frame, client initiated data requests of server data can be serviced in one period at the cost of two context switches each. Unique server budgets are no longer necessary. The client thread may be budgeted to meet worst case processing needs of both the client and the server. That is, the server budget may be small and generic while the client budget covers both the client and server needs. Therefore, budget balance is no longer an issue. The fact that multiple client/server transfers are possible in one period greatly reduces latency. Additionally, client/server queue sizes are no longer critical and permit memory/CPU time tradeoffs. A queue that is too small results in some extra context switches rather than a step function decrease in processing rate.

From the foregoing description, it should be appreciated that a balanced client/server mechanism has been provided which greatly increases CPU efficiency. While a preferred exemplary embodiment has been presented in the foregoing detailed description, it should be appreciated that a vast number of variations in the embodiments exist. It should also be appreciated that this preferred embodiment is only an example, and is not intended to limit the scope, applicability, or configuration of the invention in any way. Rather, the foregoing detailed description provides those skilled in the art with a convenient roadmap for implementing a preferred exemplary embodiment. It should be understood that various changes may be made in the function and arrangement of elements described in the exemplary preferred embodiment without departing from the spirit and scope of the invention and as set forth in the appended claims.

What is claimed is:

1. A method for transferring CPU budget and CPU control between and client thread and a server thread in a client/server pair, comprising:
assigning a CPU budget to said client thread;
executing said client thread at a scheduled time within a first period;
transferring, within said first period, CPU control and any unused CPU budget to said server thread when said client thread stops executing;
executing said server thread within said first period; and
transferring, within said first period, CPU control and any unused CPU budget to said client thread when said server thread stops executing.

2. A method according to claim 1 further comprising alternately transferring CPU control and unused CPU budget between said client thread and said server thread within said first period.

3. A method according to claim 2 further comprising terminating the execution of said client thread and said server thread when said CPU budget has expired.

4. A method according to claim 3 wherein the first step of executing comprises transferring service requests from the client to the server.

5. A method according to claim 4 wherein the second step of executing comprises transferring results of the service requests from the server to the client.

6. A method according to claim 5 wherein said client thread places service request in a client-to-server queue when said client thread is executing and wherein said server thread retrieves and processes the service request when said server thread is executing.

7. A method according to claim 6 wherein said server thread places the results of the service request in a server-to-client queue when the server thread is executing and wherein said client thread retrieves the results when said client thread is executing.

8. A method according to claim 7 wherein the first step of transferring occurs when said client thread has completed sending service requests to said client-to-server queue.

9 A method according to claim 7 wherein the first step transferring occurs when said client-to-server queue is full.

10. A method according to claim 7 wherein the first step of transferring occurs when a service request must be processed immediately.

11. A method according to claim 7 wherein the second step of transferring occurs when said server-to-client queue is full.

12. A method according to claim 7 wherein the second step of transferring occurs when said server thread empties said client-to-server queue.

13. A method according to claim 7 wherein the second step of transferring occurs when said server thread is responding to a priority service request from said client thread.

14. A method according to claim 7 wherein the first step of transferring occurs upon the occurrence of a synchronization object.

15. A method according to claim 14 wherein the second step of transferring occurs upon the occurrence of a synchronization object.

16. A method according to claim 15 wherein said synchronization object is an event.

17. A method according to claim 15 wherein said synchronization object is a semaphore.

18. A method according to claim 1 wherein the CPU budget assigned to said client thread is sufficient to complete the task of the client/server pair.

19. A method according to claim 1 further comprising assigning a CPU budget to said server thread.

20. A method for transferring CPU control between a client thread and a server thread in a client/server pair, comprising:
executing said client thread at a scheduled time within a first period;
transferring control of the CPU within said first period to said server thread when said client thread stops executing;
executing said server thread in said period; and
transferring within said first period, control of the CPU to said client thread when said server thread stop s executing.

21. A method according to claim 20 further comprising alternately transferring CPU control between said client thread and said server thread within said first period.

22. A method according to claim 20 wherein the first step of executing comprises transferring service requests from the client to the server.

23. A method according to claim 22 wherein the second step of executing comprises transferring results of the service requests from the server to the client.

24. A method according to claim 23 wherein said client thread places service requests in a client-to-server queue when said client thread is executing and wherein said server thread retrieves and processes the service requests when said server thread is executing.

25. A method according to claim 24 wherein said server thread places the results of the service requests in a server-to-client queue when the server thread is executing and wherein said client thread retrieves the results when said client is executing.

26. A method according to claim 25 wherein the first step of transferring occurs when said client thread has completed transferring service requests to said client-to-server queue.

27. A method according to claim 25 wherein the first step of transferring occurs when said client-to-server queue is full.

28. A method according to claim 25 wherein the first step of transferring occurs when a service request must be processed immediately.

29. A method according to claim 25 wherein the second step of transferring occurs when said service to client queue is full.

30. A method according to claim 25 wherein the second step of transferring occurs when said server thread empties said client-to-server queue.

31. A method according to claim 25 wherein the second step of transferring occurs when said server thread is responding to a priority service request from said client thread.

32. A method according to claim 25 wherein the first step of transferring occurs upon the use of a synchronization object.

33. A method according to claim 32 wherein the second step of transferring occurs upon the use of a synchronization object.

34. A method according to claim 33 wherein said synchronization object is an event.

35. A method according to claim 33 wherein said synchronization object is a semaphore.
